(19) United States
(12) Patent Application Publication
(10) Pub. No.: US 2016/0116908 A1
(43) Pub. Date: Apr. 28, 2016

(54) MANAGEMENT SYSTEM FOR OPTIONAL FUNCTION USAGE STATUS

(71) Applicant: FANUC Corporation, Minamitsuru-gun (JP)

(72) Inventor: Takeshi IKKI, Minamitsuru-gun (JP)

(21) Appl. No.: 14/918,759

(22) Filed: Oct. 21, 2015

(30) Foreign Application Priority Data
Oct. 22, 2014 (JP) 2014-215469

(51) Int. Cl. G05B 19/4155

(52) U.S. Cl. CPC G05B 19/4155; G05B 2219/34454

(57) ABSTRACT

An optional function usage status management system includes a numerical control device and a management device. The numerical control device includes an optional function usage status confirmation unit, an optional function usage status storage region, an optional function stop control unit configured to control to restrict use of the optional function when usage number of the optional function exceeds a predetermined upper limit, and the management device includes an optional function usage status database, an optional function usage status monitoring unit, and an optional function usage status data processing unit.

### BACKGROUND OF THE INVENTION

1. Field of the Invention

The present invention relates to a system which manages optional function usage status of a numerical control device.

2. Description of the Related Art

Heretofore, supplier of the numerical control device provides optional functions to the users by purchase.

However, the optional functions include not only optional functions always used by a user but also optional functions necessary only for short term. For the latter optional function, users demand a supplying way in which the function is available only for short term but not expensive. As a supplying way corresponding to the demand, meter rate charging system in which the fee is determined depending on the time duration the machine with the supplied function is used for (for example, Japanese Patent Laid-Open NO. 2002-318970, Japanese Patent Laid-Open NO. 2002-297254).

However, the operation time of the machining tool controlled by the numerical control device is not determined only by the kind of the optional function the numerical control device, but varies greatly dependent on the content of the machining, parameter setting, configuration and material of the workpiece to be machined, and the like. For this reason, the following problem occurs.

In the numerical control device A and the numerical control device B, both has the same optional function, as shown in FIG. 6, the numerical control device A uses the optional function more often than the numerical control device B in shorter interval. In this case, the usage time of the optional function is assumed to be same with the meter rate charging system depending on operation time, so the usage fee is same even when the usage number of the optional function differs. In addition to that, it is impossible to restrain for the optional function to be used often even when the upper limit is set for the usage time.

The users desire to make the usage fee to be inexpensive according to the usage frequency of the optional function. However it is impossible for the conventional meter rate charging system dependent on operation time to respond to the desire since the operation time of the numerical control device having the optional function is same for the above two numerical control devices. In addition to that, such a case is considered for the meter rate charging system using the installation time, that when the optional function is not used right after the purchase, the usable time may pass such that the usage time to be used is not available.

### SUMMARY OF THE INVENTION

In view of the above-described problems in the prior art techniques, a purpose of the present invention is to provide a usage status management system in which the management device managing the optional function usage status of each numerical control device records and manages not only the usage time but also the usage number of the optional function.

The optional function usage status management system according to the present invention including at least one numerical control device having optional function and configured to control a machine based on a machining program, and a management device configured to manage usage status of the optional function in association with the numerical control device, the numerical control device, includes an optional function usage status confirmation unit configured to detect usage number of the optional function and generate information of usage status of the optional function, an optional function usage status storage region configured to store the information of the usage status of the optional function generated by the optional function usage status confirmation unit, an optional function stop control unit configured to control to restrict use of the optional function when usage number of the optional function included in the information of usage status of the optional information exceeds a predetermined upper limit, and a first communication unit configured to send and receive the information of usage status of the optional function between the management device, and the management device includes a second communication unit configured to send and receive the information of usage status of the optional function between the numerical control device, an optional function usage status database configured to store the information of usage status of the optional function in association with the numerical control device, an optional function usage status monitoring unit configured to monitor the information of usage status in the optional function usage status database and send revised information of usage status to the numerical control device when revision is detected, and an optional function usage status data processing unit configured to revise the optional function usage status database based on the usage status of the optional function received by the second communication unit.

In the present invention, with the above configuration, the supplier of the numerical control device can provides the optional function with the meter rate charging system dependent on the usage number of the optional function for the users.

### BRIEF DESCRIPTION OF THE DRAWINGS

The above-described object, the other object, and the feature of the invention will be proved from the description of embodiments below with reference to the accompanying drawings. In these drawings:

FIG. 1 is a schematic block diagram of a usage status management system according to an embodiment of the present invention.

FIG. 2 is a flowchart of start processing of a usage status management system according to an embodiment of the present invention.

FIG. 3 is a flowchart of a usage status monitoring process of a usage status management system according to an embodiment of the present invention.

FIG. 4 is a flowchart of a synchronous processing from the numerical control device according to an embodiment of the present invention.

FIG. 5 is a flowchart of a synchronous processing from the management device according to an embodiment of the present invention.

FIG. 6 is a diagram explaining a problem of a charging method for optional function in prior art.

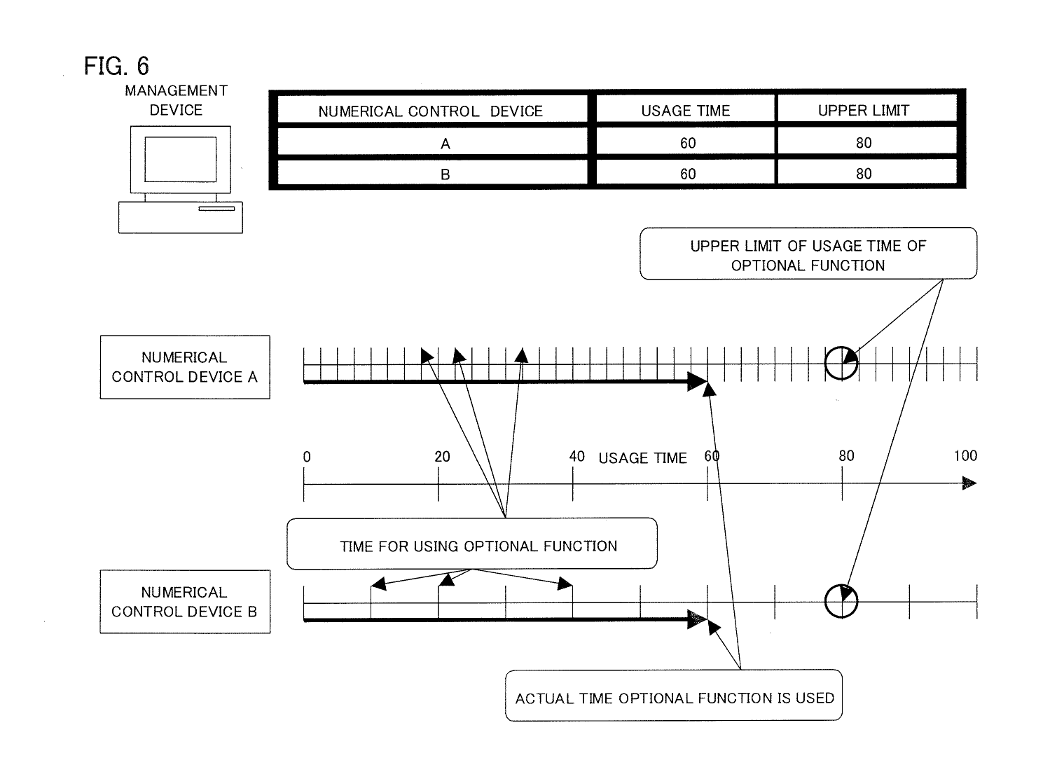

FIG. 7 is a schematic diagram explaining a charging method for optional function according to an embodiment of the present invention.

### DETAILED DESCRIPTION OF THE PREFERRED EMBODIMENTS

Usage status management method of the optional function of the numerical control device according to an embodiment of the present invention will be outlined first. When the supplier of the numerical control device provides a various kinds of functions of the numerical control device as a selectable optional function to the users, the optional functions are often provided to the user by purchase in general, but there is a case where the optional functions are provided in the meter rate charging system. When the usage fee of the optional functions are calculated in the meter rate charging system, the meter rate charging system dependent on usage time is generally used. In addition to that, the present invention provides the optional functions to the users calculating the usage fee by the meter rate charging system dependent on the usage number of the optional functions.

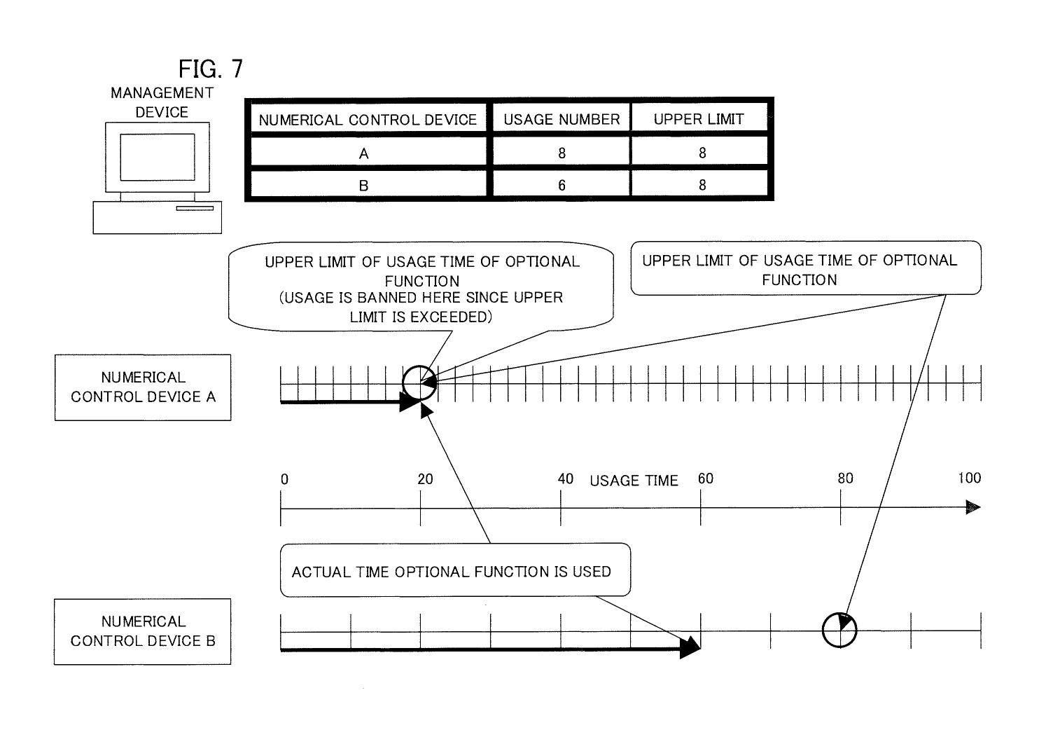

For example, in the numerical control device A and the numerical control device B, both has the same optional function, the numerical control device A is assumed to use the optional function more often than the numerical control device B in shorter interval, as shown in FIG. 7. In this case, it is possible to set appropriate usage fee corresponding to the usage number of the optional function when the usage fee is calculated in the meter rate charging system dependent on the usage number. In addition to that, setting upper limit for the usage number enables to restrain the frequent usage of the optional function.

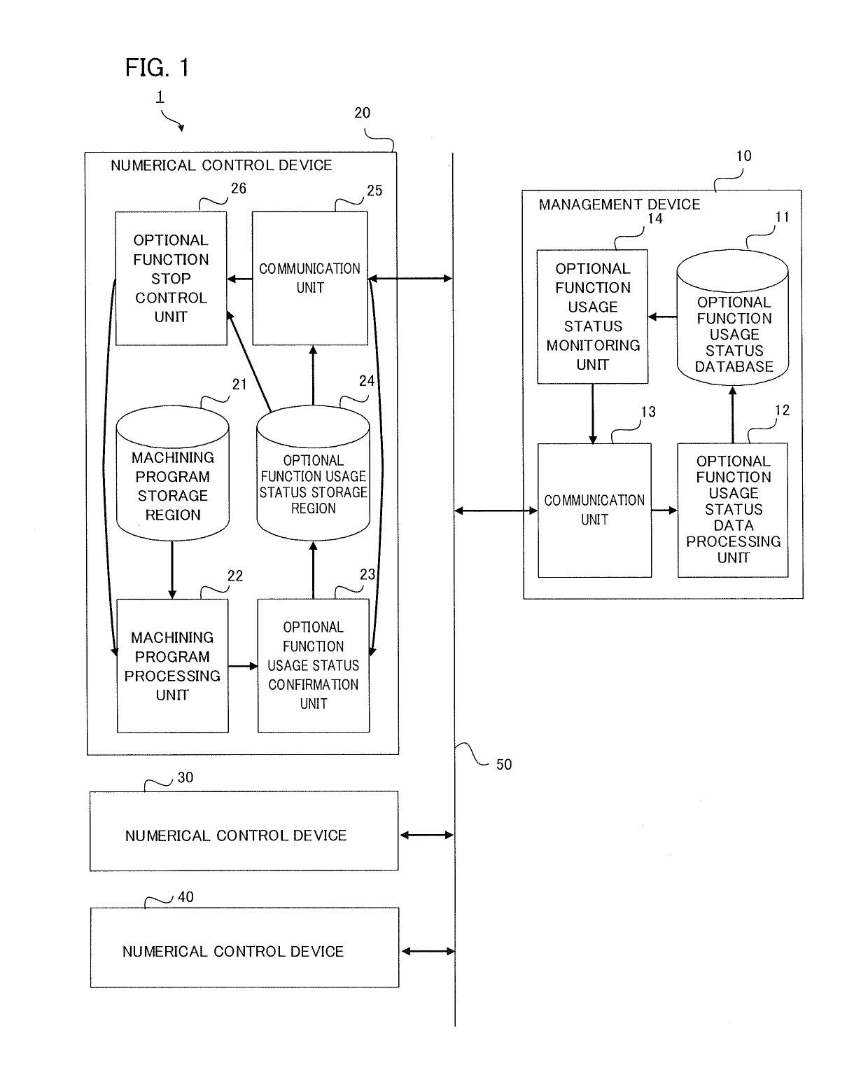

Technical configuration of the usage status management system for implementing the method mentioned above will be described. FIG. 1 is a schematic block diagram of the usage status management system according to an embodiment of the present invention. In the usage status management system according to the present embodiment, a management device 10 and a plurality of numerical control devices 20, 30, and 40 are connected via a communication line 50.

The management device 10 comprises an optional function usage status database 11 which stores usage status of the optional function of each numerical control device, an optional function usage status data processing unit 12 which manages the usage status of the optional function of each numerical control device, and a communication unit 13 which communicates with each numerical control device.

The numerical control device 20 includes a machining program storage region 21 which stores a machining program, a machining program processing unit 22 which analyzes the machining program read out from the machining program storage region 21 and control the machine, an optional function usage status confirmation unit 23 which detects the usage status of the optional function based on operation status of the machining program processing unit 22, an optional function usage status storage region 24 which stores the usage status of the optional function detected by the optional function usage status confirmation unit 23, a communication unit 25 which communicates with a management device, and an optional function stop control unit 26 which controls usage of the optional function in the machining program processing unit 22 based on the usage status of the optional function of the numerical device 20 stored in the optional function usage status storage region 24. The other numerical control devices including the numerical control devices 30, 40 have the same configuration as the numerical control device 20.

The numerical control device 20 in the present embodiment calculates and records the usage number of the optional function in the optional function usage status storage region 24 by calculating call count of code such as G code and M code, which commands the numerical control device as a machining program and is associated with the optional function. When the call count is calculated, the call count of one kind of the code may be counted. Alternatively, code call condition may be set correspond to calling way for using the optional function, such as a case in which code B is called after code A is called, and a case in which code E is called after code C is called without calling code D, and the number of the call with the calling way satisfying the call code call condition may be counted. The management device 10 communicates with the numerical control device 20 and records and manages the call count of the optional function calculated by the numerical control device 20, in the optional function usage status database 11. Usage time or the like may also be stored for some optional functions. The communication between the management device 10 and the numerical control devices 20, 30, and 40 are performed via the communication unit 13, the communication line 50, and the communication unit 25. The communication line 50 is assumed to be internet, but not limited to the internet, and may be a LAN, that is, Local Area Network.

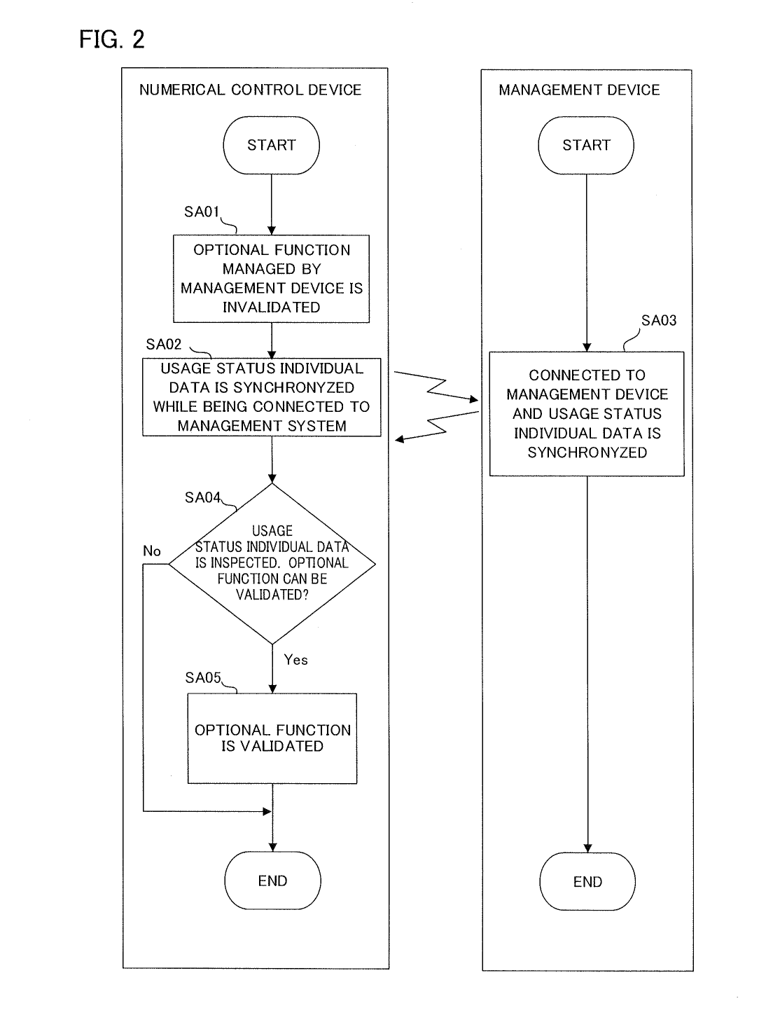

Operation of the usage status management system with the above configuration will be described below using flowcharts of FIGS. 2 to 5.

### Start Sequence

FIG. 2 is a flowchart of start processing of the numerical control device 20 and the management device 10 when the numerical control device 20 is powered on.
[Step SA01] When the numerical control device 20 is powered on, the optional function stop control unit 26 invalidates the optional function managed by the management device 10.
[Step SA02] The numerical control device 20 communicates with the management device 10 to notify the management device 10 the usage status individual data to the last powered off time stored in the optional function usage status storage region 24.
[Step SA03] The management device 10 updates the usage status individual data of the numerical control device in the optional function usage status database 11 on receiving the usage status individual data from the numerical control device 20, and sends the updated usage status individual data to the numerical control device 20.
[Step SA04] The numerical control device 20 stores the received usage status individual data in the optional function usage status storage region 24 on receiving the usage status individual data from the management device 10, and confirms the upper limit of usage of the optional function by the optional function stop control unit 26 based on the usage status individual data. The process proceeds to Step SA05 when any one of the optional functions does not reach the upper limit and usable, while the start processing ends when all of the optional functions have reached the upper limit of usage.
[Step SA05] The usable optional function is validated to be used.

### Sequence During Machining

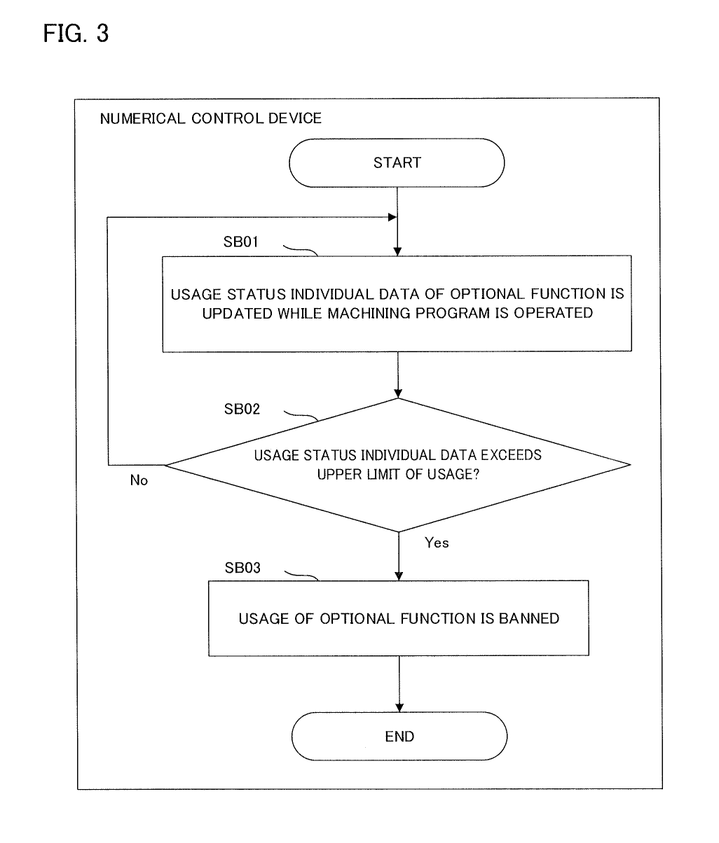

FIG. 3 is a flowchart of a usage status monitoring process of the numerical control device 20 when the machining program is operated in the numerical control device 20 for machining.
[Step SB01] The numerical control device 20 reads out the machining program stored in the machining program storage region 21 by a machining program processing unit 22, and analyzes the machining program to perform operation. The optional function usage status confirmation unit 23 counts number to be called for a code which commands the numerical control device and is associated with the optional function detected during the analysis of the machining program, then stores the usage status individual data including the call counts in optional function usage status storage region 24.
[Step SB02] The optional function stop control unit 26 monitors the usage status individual data stored in the optional function usage status storage region 24, and determines whether any one of the call counts of the optional function exceeds the set upper limit or not. The process proceeds to Step SB03 when any one of the call counts exceeds the limit, and the process returns to SB01 when not.
[Step SB03] The optional function which is determined to exceed the upper limit in Step SB02 is invalidated not to be used. The usage status individual data stored in the optional function usage status storage region 24 is updated not only by the process of Step SB01 but also by the synchronous processing of the usage status individual data to be described later. Therefore, the management device 10 invalidates the optional function not to be used which is determined to exceeds the upper limit, by executing synchronous processing of the usage status individual data when the usage status individual data of the numerical control device 20 stored in the optional function usage status database 11 is updated by an optional function usage status monitoring unit 14 and the upper limit of the optional function usage is changed.

### Synchronization of the Usage Status Individual Data

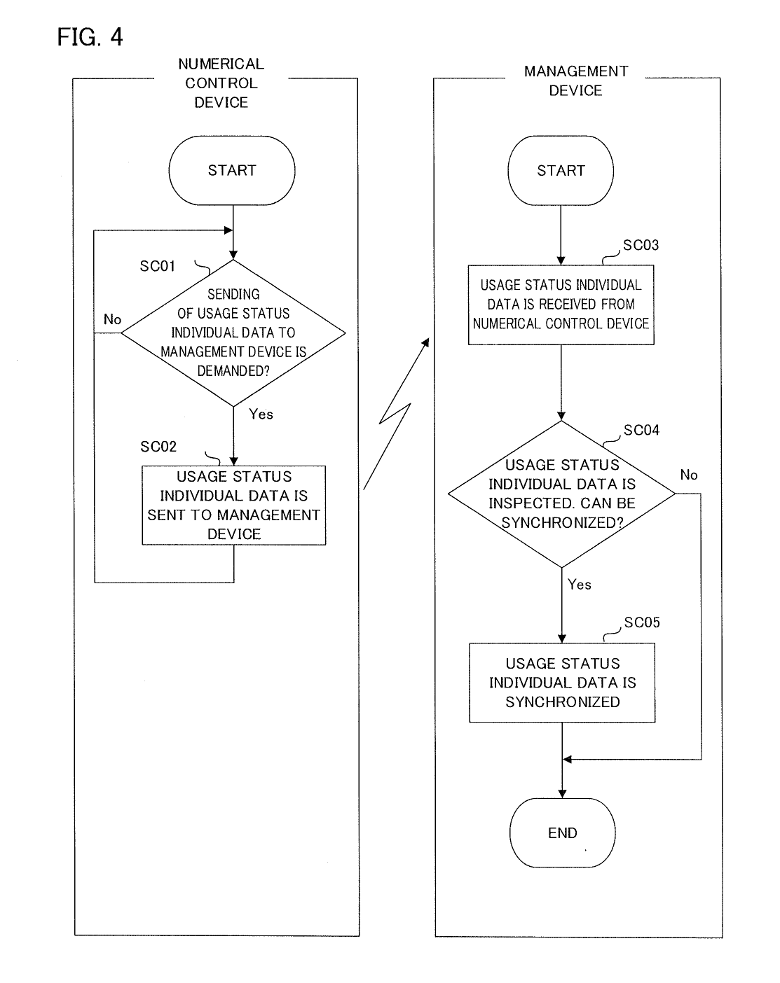

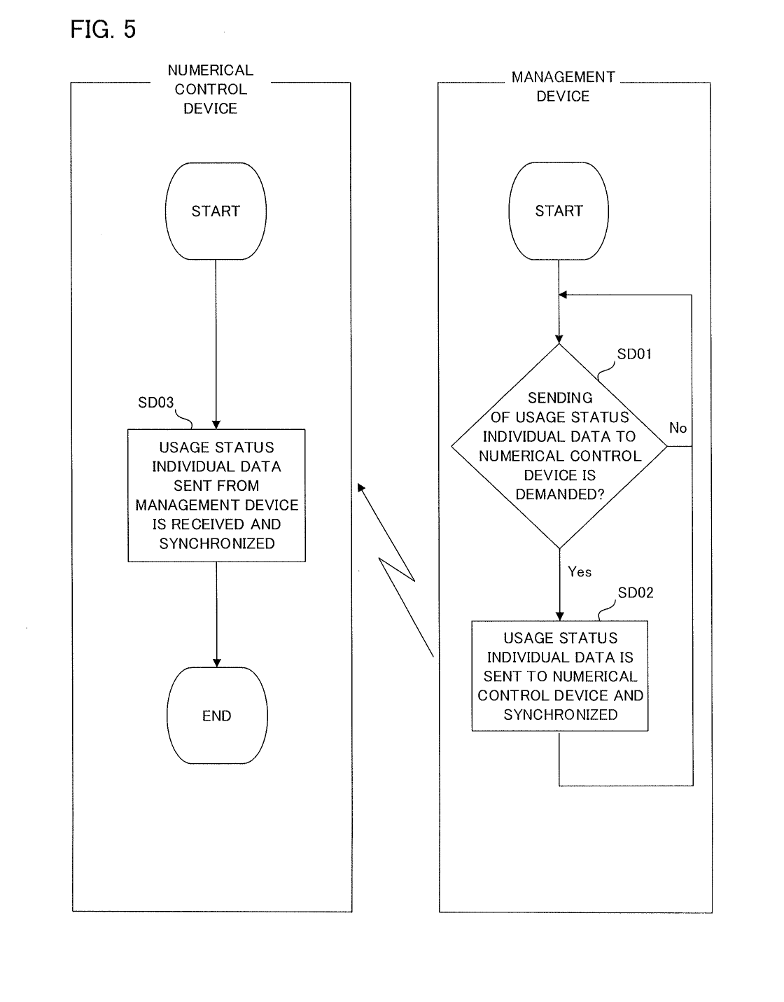

FIGS. 4 and 5 are flowcharts of a synchronous processing of the usage status individual data in the optional function usage status storage region 24 of the numerical control device and the usage status individual data in the optional function usage status database 11 of the management device 10.

FIG. 4 shows processing of reflecting the usage status individual data in the optional function usage status storage region 24 to the usage status individual data in the optional function usage status database 11. The usage status individual data of the numerical control device 20 in the optional function usage status database 11 and in the optional function usage status storage region 24 can be synchronized at not only at the start sequence but also at any time.
[Step SC01] It is determined whether command for notifying the management device 10 of the usage status individual data is output or not. The process proceeds to Step SC02 when the command for notifying the management device 10 of the usage status individual data is output, while the determination is repeated when the command is not output. Commanding of the notification of the usage status individual data from the numerical control device 20 to the management device 10 may be executed at any time. The time when the notification is commanded includes the time when the numerical control device 20 detects the optional function which exceeds the upper limit of the usage and notifies the management device 10. The time of notification may be performed not only by designating any time in the numerical control device 20, but also by demanding any time from the management device 10 to the numerical control device 20.
[Step SC02] The usage status individual data in the optional function usage status storage region 24 is sent to the management device 10.
[Step SC03] The management device 10 receives the usage status individual data from the numerical control device 20.
[Step SC04] The optional function usage status data processing unit 12 determines whether the usage status individual data received from the numerical control device 20 to be updated to the optional function usage status database 11 or not. The process proceeds to Step SC05 when the data to be updated, and the process ends when not.
[Step SC05] The usage status individual data is stored in the optional function usage status database 11, such that the usage status individual data of the numerical control device in the optional function usage status database 11 is updated.

FIG. 5 shows processing of reflecting the usage status individual data in the optional function usage status database to the usage status individual data in the optional function usage status storage region 24. The management device 10 can notify the numerical control device 20 of the usage status individual data of the numerical control device 20 in the optional function usage status database 11, when the management device 10 notifies the numerical control device 20 of the usage status individual data.
[Step SD01] The management device 10 determines whether command for notifying the numerical control device 20 of the usage status individual data is output or not. The process proceeds to Step SD02 when the command for notifying the numerical control device 20 of the usage status individual data is output, while the determination is repeated when the command is not output. The time when the notification is commanded includes the time when the optional function usage status monitoring unit 14 detects change of the upper limit of the optional function usage by updates of the usage status individual data of the numerical control device 20 stored in the optional function usage status database 11 in the management device 10, the updated usage status individual data is notified to the numerical control device 20 and the usage status individual data in the optional function usage status storage region 24 is to be updated. The time of notification may be performed not only by designating any time in the management device 10, but also by demanding any time from the numerical control device 20 to the management device 10.
[Step SD02] The usage status individual data in the optional function usage status database 11 is sent to the numerical control device 20.
[Step SD03] The numerical control device 20 stores the usage status individual data in the optional function usage status storage region 24 using the optional function usage status confirmation unit 23, such that the upper limit of the optional function usage in the usage status individual data is updated.

1. An optional function usage status management system including at least one numerical control device having optional function and configured to control a machine based on a machining program, and a management device configured to manage usage status of the optional function in association with the numerical control device, the numerical control device comprising:
an optional function usage status confirmation unit configured to detect usage number of the optional function and generate information of usage status of the optional function;
an optional function usage status storage region configured to store the information of the usage status of the optional function generated by the optional function usage status confirmation unit;
an optional function stop control unit configured to control to restrict use of the optional function when usage number of the optional function included in the information of usage status of the optional information exceeds a predetermined upper limit; and
a first communication unit configured to send and receive the information of usage status of the optional function between the management device; and the management device comprises:
a second communication unit configured to send and receive the information of usage status of the optional function between the numerical control device;
an optional function usage status database configured to store the information of usage status of the optional function in association with the numerical control device;
an optional function usage status monitoring unit configured to monitor the information of usage status in the optional function usage status database and send revised information of usage status to the numerical control device when revision is detected; and
an optional function usage status data processing unit configured to revise the optional function usage status database based on the usage status of the optional function received by the second communication unit.
